(19) United States
(12) Patent Application Publication
(10) Pub. No.: US 2014/0034650 A1
(43) Pub. Date: Feb. 6, 2014

(54) AIRCRAFT COOKING DEVICE

(71) Applicant: LUFTHANSA TECHNIK AG, Hamburg (DE)

(72) Inventors: OLIVER THOMASCHEWSKI, NORDERSTEDT (DE); CEDRIC DUSSEX, HAMBURG (DE); DOMINIK HENZE, HAMBURG (DE); ARNE BOCKHOP, HAMBURG (DE)

(73) Assignee: LUFTHANSA TECHNIK AG, Hamburg (DE)

(21) Appl. No.: 13/956,976

(22) Filed: Aug. 1, 2013

(30) Foreign Application Priority Data
Aug. 3, 2012 (DE) 102012213811.0

(51) Int. Cl. A47J 27/00

(52) U.S. Cl. CPC A47J 27/002
USPC 220/573.1

(57) ABSTRACT

Aircraft cooking device comprising a cooking vessel and a lid which can be firmly connected to the cooking vessel, wherein the aircraft cooking device is fixable on an aircraft cooking station, and wherein the lid comprises at least one movable member, through the movement of which at least one opening to the interior of the cooking vessel is exposable.

### FIELD OF INVENTION

The invention relates to an aircraft cooking device.

### BACKGROUND OF THE INVENTION

In aircrafts, food is usually prepared using special aircraft cooking devices. For this purpose, aircrafts in line haul comprise for example convection ovens for preparing packaged food.

In individually equipped aircrafts, cooking vessels in the form of pots, pans and woks are also used. In this context, in conventional commercial solutions, these are generally fixed to the cooking station by means of safety brackets, together with lids, a plurality of pots often being held in place by one safety bracket.

It is important to fix the cooking vessels in such a way that no hot drinks or food enter the cabin in an uncontrolled manner in the event of aircraft turbulence. However, these safety aspects significantly limit the configuration and in particular the handling of aircraft cooking devices.

Preparing food using known aircraft cooking devices is circuitous; in particular, the lids of the pots or pans cannot be closed or opened quickly. Also, the safety brackets which are used sometimes have to be completely disassembled so as to monitor the state of the cooking or to add ingredients. This is disadvantageous in particular in case of sudden turbulence. When the safety bracket is raised, although the cooking can be handled, in the event of turbulence there is still the risk of cooking vessels, such as pots, pans and woks, and the contents thereof entering the cabin in an uncontrolled manner and thus posing a safety risk.

The object of the invention is therefore to provide an aircraft cooking device in which the described problems are reduced.

### BRIEF SUMMARY OF THE INVENTION

The invention achieves this object by way of the features of claim 1. Thus, to achieve the object, an aircraft cooking device is proposed comprising a cooking vessel and a lid which can be firmly connected to the cooking vessel, it being possible to fix the aircraft cooking device on an aircraft cooking station, and the lid comprising at least one movable member, the movement of which can expose at least one opening to the interior of the cooking vessel. The term “cooking vessel” includes containers in which cooking can be prepared, that is to say in particular pots, pans and woks. In this context, the aircraft cooking device comprises the cooking vessel and a lid which can be firmly connected to the cooking vessel. An “aircraft cooking station” basically means a cooking station, provided with heating members, in the aircraft. The aircraft cooking station may also for example be equipped with extraction hoods.

Exposing the opening makes it possible to access the interior of the cooking vessel. No safety brackets or lids have to be dismantled, taken off or removed for this purpose; instead, moving the movable member is sufficient to provide temporary access to the cooking. In this context, an opening within the meaning of the invention makes it possible to access the cooking; this is therefore an access opening. Accordingly, it is large enough that for example ingredients and/or a wooden spoon can be moved through it.

The movable member may be configured in various ways. In a preferred embodiment, the movable member is for example radially and/or tangentially displaceable. Accordingly, it can for example be displaced on a portion of a circular path or of a spiral arc. A tangential movement direction is advantageous in particular in round pots, since this movement direction extends in the peripheral direction in the same shape as the shape of the pot.

Preferably, the movable member is in the form of a cover flap which can be displaced tangentially on the lid. In this context, the movable member thus completes a rotational movement about the central axis of the cooking vessel. In this context, it may be preferred to arrange the cover flap in a horizontal plane. In another preferred embodiment, the lid is conical in form and the movable member is displaceably arranged on part of the outer surface of the cone shape. In this embodiment, the movable member is accordingly in the form of a rotating shutter. In this embodiment, the conical lid is preferably screwed to the pot which is to be covered.

By displacing the movable member, an opening in the form of a sieve is preferably initially exposed, and this preferably makes it easily possible to drain the cooking. If the movable member is displaced further, a larger window-like opening is preferably subsequently exposed, through which for example cooking ingredients can very easily be added.

The disclosed conical lid is particularly suitable for pots. By contrast, planar lids are particularly suitable for pans or woks, although in some cases planar lids may also be preferred for pots.

In the case of planar lids, the movable member is preferably in the form of a horizontally displaceable sliding segment, which in a position as part of the lid seals the cooking vessel, and in another position exposes a window-like opening. It may also be preferred to provide a plurality of movable members, which can preferably be moved above and/or below one another.

In a further preferred embodiment of the invention, a plurality of movable members are provided, which can be moved apart to expose the opening in the manner of a shutter. In this embodiment, the movable members form the lid of the cooking vessel. Similarly to an optical shutter, during the opening process the movable members move apart in a plane, in such a way that in the centre thereof they expose an opening, the diameter of which increases continuously during the opening process. In this way, the desired opening size can be set in a targeted manner.

In another preferred embodiment of the invention, the movable members can be moved apart in the manner of a corolla to expose the opening. The movable members are initially arranged in a plane forming a closed lid, and pivot out of this plane during the opening process. For this purpose, they are preferably mounted on the cooking vessel rim in the manner of hinges. In this embodiment too, advantageously only a small opening is initially formed in the centre of the cooking vessel, the diameter of said opening constantly increasing. However, it may also be preferred for individual members to be movable independently of the “corolla” as a whole, and for it thus to be possible to create an opening to the cooking vessel interior, possible merely by moving an individual “petal”.

Preferably, the cooking vessel can be fixed on the cooking station by way of a positive connection. The positive connection is preferably provided by a thread, a holding clamp or a quick-release fastener. The positive connection may also comprise a bayonet lock or pins. This fixing is preferably provided independently of the lid, in such a way that the cooking vessel for example comprises a thread and/or can be screwed into a thread in the cooking station.

Alternatively or in addition, a holding clamp in the form of a bracket can press down and fix the cooking vessel. Preferably, the cooking vessel comprises at least one loop. The holding clamp can preferably be attached to this loop for fixing. The holding clamp may for example be attached to the handle by way of a positive connection. In this context, fixing the cooking vessel ensures that it cannot undesirably be detached from the cooking station.

Depending on the requirements, it may be preferred for the opening to close again automatically if force is no longer being applied to the movable member, or for it to be possible to expose the opening permanently. If the opening is exposed permanently, the movable member remains in the position into which it has been moved. This has the advantage that the operator has both hands available for cooking after the opening process. By contrast, automatic closure is advantageous if the risk of cooking undesirably leaving the cooking vessel is to be minimised.

In a preferred embodiment, a safety means is provided which is set up so as to close the opening automatically if the aircraft acceleration exceeds a particular threshold. The aircraft cooking device preferably comprises an acceleration sensor for this purpose.

For example, during particular flight manoeuvres or turbulence it may be preferred for the opening to be closed again automatically. 1.1 g is preferred as a threshold for a downward vertical acceleration, during which the cooking correspondingly moves upwards. A threshold of 1.5 g is preferred for a lateral acceleration. For an upward vertical acceleration, a threshold of 2 g is preferred. It is further preferred for the threshold to be an angle of inclination in the roll or pitch direction of the aircraft. Preferably, the threshold is reached at an angle of inclination of the aircraft of greater than 10°. The various thresholds may be provided individually or in any desired combination. Preferably, a plurality of thresholds are provided mutually independently, in such a way that it is sufficient to reach one threshold for the opening to be closed automatically.

Preferably, the movable member is spring-loaded. The spring-loading is preferably produced by a spring member, and may for example be provided in such a way that the opening is always automatically closed. In this case, the movable member is spring-loaded counter to the opening direction of the movable member. The safety means preferably comprises a mechanical spring system, which is set in accordance with the preferred thresholds. Preferably, the safety system is connected to the spring member. Once a provided threshold is reached, the opening is closed automatically by the spring member.

For increased safety, it may be preferred for the movable member to be made lockable. The locking completely prevents the movable member from undesirably exposing an opening.

The movable member can be moved directly, for example by means of a handle attached to the movable member. In some embodiments, however, it is preferred for the movable member to be movable by way of a tangentially and/or radially displaceable lever member. The lever member may also be in the form of a handle, and is connected to the movable member. The lever member may for example be arranged on the cooking vessel rim and the opening is exposed by displacing the lever member on the pot rim.

Preferably, the opening is in the form of a sieve opening. The sieve opening is formed by a plurality of small individual openings. The sieve opening makes it possible to drain cooking, for example to strain cooked food, without the entire contents of the cooking vessel being poured out.

The aircraft cooking device preferably comprises a valve. The valve may be of various forms. In a preferred embodiment, it is in the form of a pressure relief valve, which is for example arranged on the lid. By way of the pressure relief valve, an internal pressure build-up in a pot can for example be released, and this is advantageous in particular in the case of a sudden decompression in the aircraft.

In another preferred embodiment, the valve is in the form of a bleed valve for controlled release of steam from the cooking vessel.

Preferably, the valve comprises a grating. As a fire barrier, the grating can counter any potential flame formation.

Further, it may also be preferred to arrange a fire extinguishing member in the cooking vessel. In this case, the fire extinguishing member is preferably in the form of a CO₂ container, which may for example be provided in the lid. Once a fire is detected, the fire extinguishing member triggers automatically, in such a way that the stored CO₂ is released to extinguish the fire.

In a further preferred embodiment of the invention, the aircraft cooking device comprises a temperature and/or fire sensor which locks the movable member in the event of high temperatures in the cooking vessel. The temperature and/or fire sensor may for example comprise a bimetallic strip which locks the movable member in the closed position as a result of high temperatures in the interior of the cooking vessel. The bimetallic strip is deformed by the high temperatures, making it possible to set the locking in a simple manner in such a way that the locking takes place automatically when a critical temperature is reached.

### BRIEF DESCRIPTION OF THE DRAWINGS

The invention is described in greater detail in the following by way of preferred embodiments, referring to the appended drawings, in which:

FIG. 1 is an isometric drawing of a cooking vessel comprising a conical lid;

FIG. 2 is an isometric drawing of a cooking vessel comprising a planar lid;

FIG. 3 is an isometric drawing of a cooking vessel comprising a planar lid in the form of a shutter;

FIG. 4 is an isometric drawing of a cooking vessel comprising a lid in the form of a corolla; and

FIG. 5 is an isometric drawing of a cooking vessel comprising a lid and a water drip guide.

### DETAILED DISCLOSURE OF THE INVENTION

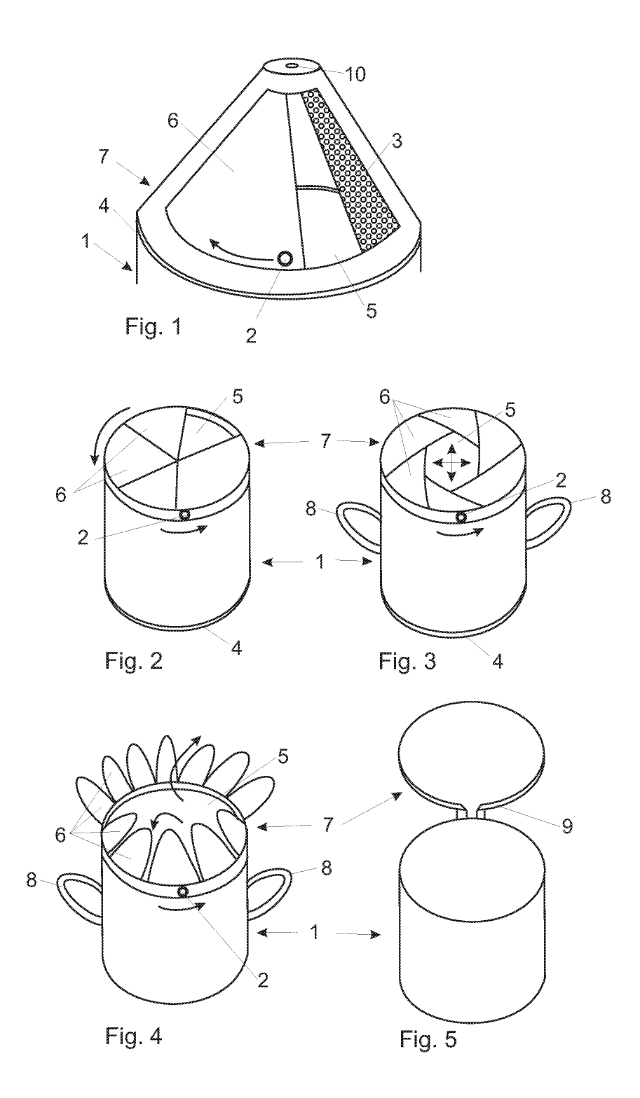

FIG. 1 shows an aircraft cooking device comprising a cooking vessel 1 in the form of a pot. A conical lid 7 is arranged on the cooking vessel 1. The cooking vessel 1 and the lid 7 can be firmly interconnected by means of a thread 4. The cooking vessel 1 can additionally be connected to the cooking station of the aircraft, by means of a second thread 4 (not shown in FIG. 1) at the base of the cooking vessel 1.

The lid 7 of the cooking vessel 1 comprises a movable member 6, which in this embodiment is in the form of a cover flap on the outer surface of the conical lid 7. The movable member 6 comprises a handle 2, by means of which the movable member 6 can be displaced in a tangential direction with simple handling. The movable member 6 is thus rotated about the central axis of the cooking vessel 1.

In this context, a movement of the movable member 6 initially leads to a sieve opening 3 being exposed. The sieve opening 3 is formed by a plurality of small individual openings. The sieve opening 3 makes it possible to drain cooking, for example to strain cooked food, without the entire contents of the cooking vessel 1 being poured out.

By way of a further tangential displacement of the movable member 6, a larger opening 5 can be exposed. The opening size of the opening 5 makes it possible to access the cooking directly, and this is advantageous in particular for tasting the cooking and for adding ingredients. In this embodiment, the movable member 6 is spring-loaded counter to the opening direction. It thus closes automatically when the handle 2 is released or when there is no force on the movable member 6 to overcome the spring-loading.

FIG. 2 shows a different embodiment of the invention. The aircraft cooking device in FIG. 2 likewise comprises a cooking vessel 1 in the form of a pot, on which in this embodiment a lid 7 of a planar configuration is arranged. The lid 7 comprises a plurality of movable members 6, which can be displaced tangentially so as to expose an opening 5, and in this context thus rotate about the central axis of the cooking vessel 1. In this context, the movable members may for example expose openings 5 of different sizes; in addition, in this case too, a sieve opening 3 may be provided if required. The movable members 6 can be displaced by means of a handle 2, which need not necessarily be firmly connected to the movable members 6, but the movement of which for example starts up a mechanism for controlling the movable members 6. The embodiment of the invention shown in FIG. 2 also comprises a thread 4, by means of which the cooking vessel 1 can be installed on an aircraft cooking station.

FIG. 3 shows a further embodiment of the invention. The cooking vessel 1, again in the form of a pot, comprises a shutter-like lid 7 in this case. Similarly to an optical shutter, a plurality of movable members 6 are provided, which in a shared movement expose a contiguous central opening 5. In this way, the diameter of the opening 5 can be set freely as required. In this context, by way of the shutter-like lid 7, a comparatively large opening 5 can be exposed. When unopened, the movable members 6 form a closed lid 7.

The cooking vessel 1 or the lid 7 comprises on the rim thereof a handle 2, by means of which the opening and closing are provided. Moving the handle 2 starts up a mechanism which controls the shutter-like closing movement of the movable members 6. Likewise, by moving the handle 2 in the closing direction the shutter can be closed. In this embodiment, the cooking vessel 1 comprises on the base plate a thread 4, by means of which it can be rigidly connected to an aircraft cooking station. In addition, the cooking vessel 1 comprises two loops 8, by means of which it is likewise possible to fix the cooking vessel 1 to an aircraft cooking station. For this purpose, the aircraft cooking device preferably comprises holding clamps, which are positively connected to the loop 8 and thus fix the cooking vessel 1 in the desired position.

FIG. 4 shows a further embodiment of the invention. In this embodiment, the cooking vessel 1 in the form of a pot comprises a lid 7, which is formed of corolla-shaped movable members 6. The individual movable members 6 are mounted on the rim of the cooking vessel 1 in the manner of hinges, in such a way that they can be pivoted about the rim of the cooking vessel 1. In the unopened position, they form a planar closed lid 7. The movable members 6 fold out of this plane during the opening process, which is preferably controlled by moving the handle 2. Similarly to a corolla, this opening takes place substantially uniformly, in such a way that the plurality of movable members 6 complete an opening movement simultaneously. If required, the cooking vessel 1 or the lid 7 may also be set up in such a way that individual movable members 6 can be moved independently, so as to expose a smaller opening 5 and thus to achieve access to the interior of the cooking vessel. The advantage of this embodiment is, among other things, that a very large opening 5 can be exposed which can virtually correspond to the internal diameter of the cooking vessel 1. In this embodiment, the cooking vessel is preferably fixed by means of the loops 8, to which at least one holding clamp may be attached.

As disclosed previously, individual or a plurality of movable members 6 may be spring-loaded, in such a way that the opening 5 is closed automatically. In general, however, if required latching steps may also be provided into which the movable members 6 latch, as a result of which they permanently expose the opening 5 in a particular position or size. Alternatively or in addition, a safety means may be provided, which automatically closes the opening 5 if particular acceleration thresholds are exceeded.

In FIG. 5, a cooking vessel 1 is shown comprising a lid 7 which comprises a water drip guide 9. The water drip guide 9 leads water which condenses on the lid back into the cooking vessel 1 in a controlled manner.

What is claimed is:

1. An aircraft cooking device comprising a cooking vessel and a lid which can be firmly connected to the cooking vessel, wherein the aircraft cooking device is fixable on an aircraft cooking station, wherein the lid comprises at least one movable member, through the movement of which at least one opening to the interior of the cooking vessel is exposable.

2. The aircraft cooking device according to claim 1, wherein the movable member is radially and/or tangentially displaceable.

3. The aircraft cooking device according to claim 1, wherein the lid comprises a plurality of movable members.

4. The aircraft cooking device according to claim 3, wherein the plurality of movable members can be moved apart to expose the opening in the manner of a shutter.

5. The aircraft cooking device according to claim 3, wherein the plurality of movable members for exposing the opening can be moved apart in the manner of a corolla.

6. The aircraft cooking device according to claim 1, wherein the movable member is in the form of a cover flap.

7. The aircraft cooking device according to claim 1, wherein the cooking vessel is fixable on the aircraft cooking station by way of a positive connection.

8. The aircraft cooking device according to claim 7, wherein the cooking vessel comprises at least one loop, wherein a holding clamp is attachable to this loop for fixing.

9. The aircraft cooking device according to claim 1, wherein the opening is permanently exposable.

10. The aircraft cooking device according to claim 1, wherein a safety means is provided which is set up so as to close the opening automatically if the aircraft acceleration and/or the angle of inclination of the aircraft exceeds a particular threshold.

11. The aircraft cooking device according to claim 1, wherein the movable member is spring-loaded.

12. The aircraft cooking device according to claim 1, wherein the lid is conical in form and the movable member is displaceably arranged on part of the outer surface of the conical shape.

13. The aircraft cooking device according to claim 1, wherein the movable member is movable by way of a radially and/or tangentially displaceable lever member.

14. The aircraft cooking device according to claim 1, wherein the opening is in the form of a sieve opening.

15. The aircraft cooking device according to claim 1, wherein the aircraft cooking device comprises an acceleration and/or fire sensor.
